(19) United States
(12) Patent Application Publication
(10) Pub. No.: US 2014/0279049 A1
(43) Pub. Date: Sep. 18, 2014

(54) SOCIAL PRODUCT REVEAL

(71) Applicants: Garry Wiseman, Saratoga, CA (US); Michael Lenahan, Moraga, CA (US); Ben Mitchell, Oakland, CA (US)

(72) Inventors: Garry Wiseman, Saratoga, CA (US); Michael Lenahan, Moraga, CA (US); Ben Mitchell, Oakland, CA (US)

(21) Appl. No.: 14/211,228

(22) Filed: Mar. 14, 2014

Related U.S. Application Data
(60) Provisional application No. 61/791,994, filed on Mar. 15, 2013.

(51) Int. Cl. H04L 12/58; G06Q 50/00; G06Q 30/02; G06F 3/0481; G06F 3/0484

(52) U.S. Cl. CPC H04L 51/32; G06F 3/04817; G06F 3/04842; G06Q 30/0269; G06Q 50/01
USPC 705/14.66; 709/206; 715/752

(57) ABSTRACT

A system comprising a computer-readable storage medium storing at least one program and a computer-implemented method for providing a social product reveal. Consistent with some embodiments, the method may include presenting content to a first user with a reference to an interaction with the content by a second user. The reference to the interaction conceals the identity of the second user from the first user. The method may further include receiving a request from the first user to reveal the identity of the second user. In response to receiving the request to reveal, a communication is sent to the second user requesting the reveal of his or her identity. Upon receiving a confirmation to reveal from the second user, the identity of the second user is revealed to the first user.

### PRIORITY

This application is a non-provisional of, and claims the benefit of priority under, 35 U.S.C. §119(e) from U.S. Provisional Application Ser. No. 61/791,994, entitled “SOCIAL PRODUCT REVEAL,” filed on Mar. 15, 2013, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2014, All Rights Reserved.

### TECHNICAL FIELD

This application relates to data processing. In particular, example embodiments may relate to systems and methods for social and community based shopping services.

### BACKGROUND

Websites often provide social sharing features in conjunction with the presentation of content to increase a sense of community for the viewing members or users of the website. An example of such a feature is providing references to social network activity related to content being presented (e.g., “John Smith has purchased this item”). Although such features have the potential to increase user engagement with content, these features are currently limited in the types and amount of information they may share with users. In particular, a website cannot simply start sharing the activities of its users because users must first opt-in to the sharing of their activities before a website may share the activity with other users. Users may be hesitant to opt-into sharing all their activities with certain other users, or may not feel comfortable sharing certain activities with any users. As a result, the amount of content that may be presented in such situations may be limited, and thus, the potential for increasing engagement as a result of sharing such activities may be limited.

### BRIEF DESCRIPTION OF THE DRAWINGS

Various ones of the appended drawings merely illustrate example embodiments of the present invention and cannot be considered as limiting its scope.

FIG. 1 is a network diagram depicting a network system having a client-server architecture configured for exchanging data over a network with a content publisher, according to an example embodiment.

FIG. 2 is an interaction diagram depicting example exchanges between multiple client devices, and an application server, consistent with some embodiments.

FIG. 3A is an interface diagram illustrating content presented as part of a search results page, consistent with some embodiments.

FIG. 3B is an interface diagram illustrating a reveal request window in conjunction with the search results page, consistent with some embodiments.

FIG. 3C is an interface diagram illustrating a user prepared reveal request, consistent with some embodiments.

FIG. 4 is an interface diagram illustrating an example reveal request message sent to a client device of an anonymized user, consistent with some embodiments.

FIG. 5 is an interface diagram illustrating another example reveal request message sent to a client device of an anonymized user, consistent with some alternative embodiments.

FIG. 6 is a block diagram illustrating various functional modules of a marketplace application, which is provided as part of the network system, consistent with some embodiments.

FIG. 7 is a flowchart illustrating a method for providing a social product reveal within a user interface provided by an online marketplace, consistent with some embodiments.

FIG. 8 is a flowchart illustrating a method for routing an inquiry related to an item for which multiple anonymized users have provided an interaction, consistent with some embodiments.

FIG. 9 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details. In accordance with the present disclosure, components, process steps, and data structures may be implemented using various types of operating systems (OS), programming languages, computing platforms, computer programs, and/or general purpose machines.

Example methods and systems to provide a social product reveal within a user interface of an online marketplace are described. An online marketplace is a website or mobile application where a user may buy or sell goods or services (referred to collectively as “items”) from a provider of the online marketplace or other users of the online marketplace.

Aspects of the present disclosure may involve the presentation of content in an online marketplace “feed” or other user interface (UI). A feed is an aggregation of selected pieces of content provided to the user in an online marketplace. The content included in the marketplace feed and other user interfaces may, for example, include listings describing items for sale, related articles, reviews of items for sale, reviews of (or other information about) sellers, information about the online marketplace, special offers or discounts available to the user, information about people identified by the user as a “friend” (also referred to as a “connection” or “contact”) in a social network, or other information determined to be relevant to the user. Consistent with some embodiments, the presented content may have been previously interacted with by a social network contact of the viewing user. In such instances, the presentation of the content may include a reference to the interaction, although the social network contact that provided the interaction is not identified. Because many users have many social contacts (e.g., 5 to 1000+) within any given social network, the user may not be able to identify which social network contact(s) provided the interaction.

The content may be highlighted using text, colors, sound, a haptic feedback, or other interface element. The highlight may indicate a number of interacting contacts, a degree of interaction of the social network contacts, a respective degree of interaction of the social network contacts, a degree of familiarity between the user and the social network contact, or some other information about the interactions.

If the user desires to know the identity of the social network contact who provided the interaction, the user may request that the social network contact be revealed using, for example, a computer-implemented request module. The request may cause a communication such as an email, a Short Message Service (SMS) message, social network chat or message, or the like to be sent to the social network contact(s) who provided the interaction. Based on the social networks contact's response to the communication, a second communication may be sent by a computer-implemented communication module or by another communication method used by the social network contact to the user identifying or declining to identify the social network contact. Once a social network contact is revealed to the user, the user may communicate directly with the revealed contact to, for example, request more information about the content or make some other request.

In one example scenario, Joe logs into an online marketplace account (e.g., eBay.com) and upon opening the homepage, Joe is presented with a variety of items in a marketplace feed. One of the items, a 2-person lightweight tent, has the following text below it “One of your friends bought this item” along with a link that reads “Questions about this item? Ask your friend to reveal themselves!”

Since Joe is considering taking his son camping this summer, he is curious as to why this friend bought this particular tent and what they think of it. He clicks the link and a form appears where he can enter a message to the friend regarding the item. After entering a short message to his friend asking about the tent and its quality, he clicks the button to submit the form. Joe now sees a page that displays a message telling him that an invitation for his friend to reveal themselves has been sent and he will receive a notification once his friend responds.

Harry, who is the friend who purchased the tent, notices both a notification pushed to his smartphone as well as an email arriving in his inbox from the online marketplace. He clicks on the notification which explains that his friend, Joe, would like to talk to him about his purchase of the tent but right now cannot see who purchased this item. He also sees Joe's message regarding the tent quality. Harry decides to write a response and to reveal himself as being the purchaser. Before hitting the form submit button he also notices an opt-out link for any further reveal requests. However, he goes ahead and submits his note back to Joe who is then notified that Harry has messaged him regarding the tent listed for sale on the online marketplace.

FIG. 1 is a network diagram depicting a network system 100, according to one embodiment, having a client-server architecture configured for exchanging data over a network. The network system 100 may include a network-based marketplace 102 in communication with client devices 104A and 104B and third party server 106.

The network-based marketplace 102 may communicate and exchange data within the network system 100 that may pertain to various functions and aspects associated with the network system 100 and its users. The network-based marketplace 102 may provide server-side functionality, via a network 108 (e.g., the Internet), to one or more client devices (e.g., client devices 104A and 104B). The client devices 104A and 104B may be operated by user 110 and user 112, respectively. The user 110 and user 112 represent example users that utilize the network system 100 to exchange data over the communication network 108. These data transactions may include transmitting, receiving (communicating), and processing data to, from, and regarding content and users of the network system 100. The data may include, but are not limited to: images; video or audio content; user preferences; product and service feedback, advice, and reviews; product, service, manufacturer, and vendor recommendations and identifiers; product and service listings associated with buyers and sellers; product and service advertisements; auction bids; and transaction data, among other things.

In various embodiments, the data exchanged within the network system 100 may be dependent upon user-selected functions available through one or more client or user interfaces. The user interfaces may be associated with a client device, such as the client device 104A using a web client 114. The web client 114 may be in communication with the network-based marketplace 102 via a web server 122. The user interfaces may also be associated with the client device 104B using a web client 114, such as a client application in communication with the network-based marketplace 102, or a third party server 106 (e.g., one or more servers or client devices 104A and 104B) hosting a third party application 120.

The client devices 104A and 104B may be any of a variety of types of devices. For example, the client devices 104A and 104B may be mobile devices such as smartphones such as an iPhone® or other mobile device running the iOS® OS, the Android® OS, a BlackBerry® OS, the Microsoft® Windows® Phone OS, Symbian® OS, or webOS®. Consistent with some embodiments, the client devices 104A and 104B may alternatively be a tablet computer, such as an iPad or other tablet computer running one of the aforementioned operating systems. In some embodiments, the client device 104A and 104B may also be a personal digital assistant (PDA), a personal navigation device (PND), a handheld computer, a desktop computer, a laptop or netbook, a set-top box (STB) such as provided by cable or satellite content providers, a wearable computing device such as glasses or a wristwatch, a multimedia device embedded in an automobile, a global positioning system (GPS) device, a data enabled book reader, a video game system console such as the Nintendo Wii®, the Microsoft Xbox 360®, the Sony PlayStation 3®, or other video game system consoles.

The client devices 104A and 104B may interface via a connection 118 with the communication network 108 (e.g., the Internet or wide area network (WAN)). Depending on the form of the client device 104A and 104B, any of a variety of types of connections 118 and communication networks 108 may be used. For example, the connection 118 may be code division multiple access (CDMA) connection, a Global System for Mobile communications (GSM) connection, or other type of cellular connection. Such a connection 118 may implement any of a variety of types of data transfer technology, such as single carrier radio transmission technology (1xRTT), evolution-data optimized (EVDO) technology, general packet radio service (GPRS) technology, enhanced data rates for GSM Evolution (EDGE) technology, or other data transfer technology (e.g., fourth generation wireless, 4G networks). When such technology is employed, the communication network 108 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks).

In another example, the connection 118 may be wireless fidelity (Wi-Fi, IEEE 802.11x type) connection, a Worldwide Interoperability for Microwave Access (WiMAX) connection, or another type of wireless data connection. In such an embodiment, the communication network 108 may include one or more wireless access points coupled to a local area network (LAN), a WAN, the Internet, or other packet-switched data network. In yet another example, the connection 118 may be a wired connection, for example an Ethernet link, and the communication network 108 may be a LAN, a WAN, the Internet, or other packet-switched data network. Accordingly, a variety of different configurations are expressly contemplated.

FIG. 1 also illustrates the third party application 120 executing on the third party server 106 that may offer one or more services to users of the client devices 104A and 104B. The third party application 120 may have programmatic access to the network-based marketplace 102 via the programmatic interface provided by an application program interface (API) server 124.

In some embodiments, the third party application 120 may be associated with a vendor, a merchant, or any organizations that may conduct transactions with or provide services to the users of the client devices 104A and 104B. For some example embodiments, the third party application 120 may correspond to a social network service (e.g., Facebook®, Twitter®, Google+®, Pinterest®, Svpply®, or the like) that may provide a platform for members to build and maintain social networks and relations among other members. To this end, the social network service may allow members to share ideas, pictures, posts, activities, events, and interests with other members of the social network. A social network service may provide a representation of each member in the form of a social network profile. The social network profile of each member may contain information about the member (hereinafter referred to as “social data”) such as demographic information (e.g., gender, age), geographic information (e.g., a user's hometown, a user's current location), interests, activities, interactions, and social network connections of the members.

For purposes of the present disclosure, a social network “connection,” also referred to as being “connected” on a social network or having a social network “contact,” may include situations in which there is a reciprocal agreement between members of the social network to be linked on the social network, as well as situations in which there is only a singular acknowledgement of the “connection” without further action being taken by the other member. In the reciprocal agreement situation, both members of the “connection” acknowledge the establishment of the connection (e.g., friends). In the singular acknowledgement situation, a member may elect to “follow” or “watch” another member. In contrast to reciprocal agreement, the concept of “following” another member typically is a unilateral operation because it may not call for acknowledgement or approval by the member that is being followed. Members of a social network that are connections are said to have a “direct relationship” as opposed to an “indirect relationship,” which would refer to members that share connections, but are not themselves connections.

Turning specifically to the network-based marketplace 102, the API server 124 and web server 122 are coupled to, and provide programmatic and web interfaces respectively to, an application server 126. The application server 126 may, for example, host a marketplace application 128, which may provide a number of marketplace functions and services to users that access the network-based marketplace 102. The application server 126 may be coupled via these interfaces to the communication network 108, for example, via wired or wireless interfaces. The application server 126 is, in turn, shown to be coupled to a database server 130 that facilitates access to one or more databases 132. In some examples, the application server 126 can access the database 132 directly without the need for a database server 130. In some embodiments, the database 132 may include databases both internal and external to the network-based marketplace 102.

The database 132 may store data pertaining to various functions and aspects associated with the network system 100 and its users. For example, user accounts for users of the network-based marketplace 102 may be stored and maintained in the database 132. Each user account may comprise user data that describes aspects of a particular user. The user data may include demographic data, user preferences, transaction histories, and financial information.

The user data may also include a record of user activity, consistent with some embodiments. Accordingly, the network-based marketplace 102 may monitor, track, and record the activities and interactions of a user, using one or more devices (e.g., client device 104A), with the various modules of the network system 100. Accordingly, in some embodiments, the user data may include past keyword searches that users have performed, web pages viewed by each user, products added to a user wish list or watch list, products added to an electronic shopping cart, and products that the users own.

While the network system 100 shown in FIG. 1 employs a client-server architecture, the present inventive subject matter is, of course, not limited to such an architecture, and could equally well find application in an event-driven, distributed, or peer-to-peer architecture system, for example. The various applications and modules of the application server 126 may also be implemented as standalone systems or software programs, which do not necessarily have networking capabilities.

FIG. 2 is an interaction diagram depicting example exchanges between multiple client devices and an application server, consistent with some embodiments. In particular, FIG. 2 illustrates interactions between the client devices 104A and 104B and the application server 126. As shown, initially the user 112 may interact with content published by the network-based marketplace 102 through utilization of functionality provided by a mobile application executing on the client device 104B and designed for use with the network-based marketplace 102.

Interactions, sentiments, engagements, or other social actions (inclusively referred to as “interactions”) may include actions such as “liking” the content, viewing the content, indicating a desire for more information about the content (e.g., including the content in a poll, comparing the content to similar content, using an interactive model of the content), sharing content with a social network, checking-in to a location related to the content, indicating a desire to have or purchase the content (e.g., adding the content to a wishlist, registry, or shopping cart), or purchasing an item described by the content. For purposes of the present disclosure, a “check-in” refers to a service provided by a social network that allows users to “check-in” to a physical space or virtual space and share their location with other users of the social network. In some embodiments, these interactions may be obtained via publically accessible API from one or more social network services (e.g., Facebook, Twitter, and Pinterest). A record of these interactions may be stored in a database (e.g., database 132) that identifies the content (or aspects of the content), the social network connection, a timestamp of the interaction, and other data about the interaction. In some instances, the content may be identified more generally or more narrowly. For example, if the content relates to a car, the content may be identified generally by make, more narrowly by make and model, and more narrowly still by make, model, and year.

Next, the application server 126 may provide the client device 104A instructions to present the content to the user 110. The content may be presented by the client device 104A with an anonymized reference to the interaction with the content by the user 112 of the client device 104B. The reference is “anonymized” in that the actual identity of the user providing the interaction (e.g., user 112) is hidden from the user viewing the content (e.g., user 110). In such a manner, the anonymized reference may conceal the identity of the user 112 while identifying a relationship the user 110 has with the user 112. As used herein, the “identity” of a user refers to a specific identifier of the user such as a name, a title, a profile name, an email address, or any other type of moniker that may be used to identify a user.

Other than the reference to the interaction, the presentation of the content on the client device 104A may be unrelated to the previous interaction with the content by the user 112 and may occur at any time subsequent to the interaction. In an example, the content is presented to the user 110 in a marketplace feed upon signing into an account with the network-based marketplace 102.

As another example, FIG. 3A is an interface diagram illustrating content presented as part of a search results page 300, consistent with some embodiments. In particular, the search results page 300 is illustrated to include a set of search results returned in response to a query submitted by the user 110 for “tablet” in the category “iPads, Tablets & eBook Readers.” In addition to the set of search results, the search results page 300 includes a social banner 302 comprised of items 304-310. As illustrated, the social banner 302 includes an anonymized reference 312 to interactions by “friends” of the user 110 with the items 304-310 (e.g., “12 friends like tablets”).

In addition to referencing the previous interaction, the presentation of the social banner 302 with items 304-310 may provide the user 110 with the ability to request a reveal of the anonymized identity of the user or users providing the interaction (e.g., the user 112). For example, FIG. 3B is an interface diagram illustrating a reveal request window 314 in conjunction with the search results page 300, consistent with some embodiments. As illustrated, the reveal request window 314 identifies the item 304 (e.g., “Samsung Galaxy Tab 2 7.0) and provides a further anonymized reference (e.g., “1 friend likes this”) to a previous interaction by a “friend” (e.g., user 112) of the user 110. The reveal request window 314 also includes a field 316 for the user 110 to submit an inquiry regarding the item 304.

FIG. 3C is an interface diagram illustrating a user prepared reveal request, consistent with some embodiments. As shown, the user 110 has entered an inquiry regarding the item 304 into the field 316 of the reveal request window 314. Upon receiving an appropriate user input from the user 110 to submit the reveal request (e.g., using the “Enter” key, or through selection of a “submit” button), the reveal request may be transmitted to the application server 126.

Returning to FIG. 2, the request to reveal the identity of the user 112 may be transmitted from the client device 104A to the application server 126. As discussed above in reference to FIGS. 3B and 3C, the request may also include an inquiry related to the content, consistent with some embodiments. The application server 126 may then communicate the request message to the client device 104B. For example, FIG. 4 is an interface diagram illustrating an example reveal request message sent to a client device of an anonymized user, consistent with some embodiments. In particular, FIG. 4 illustrates a notification 400 displayed on the client device 104B of the user 112. The notification 400 is delivered to the client device 104B in response to the reveal request submitted by the user 110. As shown, the notification 400 may identify the requesting user (e.g., user 110) by name (e.g., “Kevin”) and reference the request. Although FIG. 4 illustrates a message being delivered via an applicable push notification service, the communication of such a message is, of course, not limited to such a delivery platform, and may, in other embodiments, utilize any one of a number of message delivery networks and platforms to deliver messages.

As another example, FIG. 5 is an interface diagram illustrating another example reveal request message sent to a client device of an anonymized user, consistent with some alternative embodiments. In particular, FIG. 5 illustrates a message 500 transmitted to an account of the user 112 hosted by the network-based marketplace 102, which is accessed by the user 112 on the client device 104B. As shown, the message 500 identifies the request user (e.g., user 110) and the item to which the message 500 pertains (e.g., item 304). The message 500 further includes the inquiry of the user 110 related to the item 304. The messaging service provided by the network-based marketplace 102 may provide the user 112 with the ability to respond to the message 500 through selection of the button 502. Upon receiving selection of the button 502, the application server 126 may cause an additional page to be presented, whereupon the user 112 may prepare a response to the inquiry.

Returning to FIG. 2, the client device 104B may then transmit a reply to the request based on input by the user 112 to the application server 126. The reply may include a response as to whether the identity of the user 112 is to be revealed, and may further include an answer to any inquiries about the content that may have been included in the request. As shown, the application server 126 may then reveal the identity of the user 112 to the user 110 of the client device 104A. The identity of the user 112 may be presented on the client device 104A to the user 110 in place of the previous anonymized reference or in a message to the user 110. In instances in which the identity of the user 112 is revealed via a message, such a message may further include the answer prepared by the user 112 to the inquiry submitted by the user 110 regarding the content. Upon revealing the identity of the user 112 to the user 110, the application server 126 may facilitate further communications between the devices (e.g., client device 104A and 104B) of the users 110 and 112.

It shall be appreciated that, in some embodiments, the reply to the request to reveal may be sent directly to the client device 104A, without the need for application server 126. Further, it shall be appreciated that, in some embodiments, the requests, replies, and other communications transmitted by the application server 126 may not be sent directly to the client devices 104A and 104B, but rather to accounts of the user 110 and 112 that may be accessed by and viewed on the client devices 104A and 104B, respectively.

FIG. 6 is a block diagram illustrating an example embodiment of multiple modules forming the marketplace application 128, which is provided as part of the network system 100 of FIG. 1. The module of the marketplace application 128 may be hosted on dedicated or shared server machines that are communicatively coupled to enable communications between server machines. Each of the modules 600-624 are communicatively coupled (e.g., via appropriate interfaces) to each other and to various data sources, so as to allow information to be passed between the modules 600-624 of the marketplace application 128 or so as to allow the modules 600-624 to share and access common data. The various modules of the marketplace application 128 may further access one or more databases 132 via the database servers 130. Further, while the modules 600-624 of FIG. 6 are discussed in the singular sense, it will be appreciated that, in other embodiments, multiple modules 600-624 may be employed. Moreover, while the modules 600-624 of FIG. 6 are shown to all form part of the marketplace application 128, it will be appreciated that, in alternative embodiments, any one of the modules 600-624 may form part of a service that is separate and distinct from the network-based marketplace 102.

The marketplace application 128 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 128 is shown to include a publication module 600 and an auction module 602, which support auction-format listing and price setting mechanisms (e.g., English, Dutch, Vickrey, Chinese, Double, Reverse auctions etc.). The auction module 602 may also provide a number of features in support of such auction-format listings, such as a reserve price feature whereby a seller may specify a reserve price in connection with a listing, and a proxy-bidding feature whereby a bidder may invoke automated proxy bidding.

A fixed-price module 604 may support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

A store module 606 may allow sellers to group their product listings (e.g., goods and/or services) within a “virtual” store, which may be branded and otherwise personalized by and for the sellers. Such a virtual store may also offer promotions, incentives, and features that are specific and personalized to a relevant seller. In one embodiment, the listings and/or transactions associated with the virtual store and its features may be provided to one or more users.

Navigation of the network-based marketplace 102 may be facilitated by a navigation module 608. For example, a search module may, inter alia, enable keyword searches of listings published via the network-based marketplace 102. A browser module may allow users via an associated UI to browse various category, catalogue, inventory, social network, and review data structures within the content publisher 102. Various other navigation modules 608 (e.g., an external search engine) may be provided to supplement the search and browsing module. Consistent with some embodiments, the results for keyword searches of listings published via the network-based marketplace 102 may be filtered to include only listings corresponding to social network connections of the user (e.g., indicated friends and family).

An electronic shopping cart module 610 is used to create an electronic shopping cart used by users of the network-based marketplace 102 to add and store products (e.g., goods and services) listed by the store module 606. The electronic shopping cart module 610 may also be used to “check out,” meaning a user may purchase products in the electronic shopping cart. The electronic shopping cart module 610 may facilitate the transactions by automatically finding the products in the electronic shopping cart across at least one or all of a predefined set of vendors, a comparison shopping site, an auction site, and so forth. In various embodiments, the selection criteria for which vendor or vendors to purchase from may include, but is not limited to, criteria such as lowest cost, fastest shipping time, preferred or highest rated vendors or sellers, or any combination thereof.

A payment module 612 may provide a number of payment services and functions to users. The payment module 612 may allow users to accumulate value (e.g., in a commercial currency, such as the U.S. dollar, or a proprietary currency, such as “points”) in accounts, and then later to redeem the accumulated value for products (e.g., goods or services) that are made available via the payment module 612. For some example embodiments, the payment module 612 generally enables transfer of values (e.g., funds, reward points, etc.) from an account associated with one party (e.g., a sender) to another account associated with another party (e.g., a receiver).

A recommendation module 614 may provide recommendation services and functions to users of the network-based marketplace 102. In some embodiments, the recommendation module 614 may receive requests for recommendations, and, in turn, provide a recommendation to the user based on information contained in the user's corresponding user profile. In some embodiments, the recommendation module 614 may automatically generate and provide a recommendation based on the activity of the user. The recommendations provided by the recommendation module 614 may contain one or more items (e.g., products offered for sale, articles, blogs, movies, social network connections, etc.) that may potentially interest a user. The recommendations may, for example, be based on previous products purchased by the user or a social network connection of the user, a web page viewed by the user, or an item given favorable feedback by the user or a social connection of the user.

A relationship module 616 may identify relationships between users of the network-based marketplace 102. The relationship module 616 may identify relationships using user data (e.g., maintained as part of user accounts) and social data. Relationships may, for example, be based on users being connected to each other on a social network, users being included in each other's list of contacts (e.g., cellphone contacts or email contacts), being mutually connected to other users on a social network (e.g., indirect relationships), having similar purchase histories, having similar browsing histories, having similar interests (e.g., as specified in social data about the users), being members of the same group or organization, or other similarities between users.

A user interface module 618 may generate user interfaces for the various aspects and services provided by the network-based marketplace 102, discussed herein, for display to users. For example, the user interface module 618 may generate user interfaces for services such as searching for items on the network-based marketplace 102 (e.g., search bars and search results pages), browsing and comparing item listings, facilitating the purchase of items, or the like. Such interfaces may include the presentation of content with anonymized references to interactions with the content. As another example, the user interface module 618 may work in conjunction with a feed module 620 to generate marketplace feeds for users of the network-based marketplace 102.

The feed module 620 is responsible for obtaining and aggregating content to populate a marketplace feed. The pieces of content appearing in the feed may be selected by the feed module 620 based on user data about a user (e.g., maintained as part of user accounts of the network-based marketplace 102) including, for example, the user's purchasing or selling history within the online marketplace, searches performed or saved by the user, inputs provided by the user, or the like. Consistent with some embodiments, the content in the feed may be selected based on an amount of money available in a financial account of the user such as banking account or a PayPal account.

The pieces of content may be selected so that it appears to the user as if the feed itself has no end and continues indefinitely. The searches performed by a user may be conceptualized to select further items in other categories. For example, the search “Batman Returns DVD” (in category “movies”) may be conceptualized to “Batman” and used to select items related to “Batman” (in other categories such as “Toys,” “Clothing,” etc.) to the feed generated for the user.

In some instances, the user may be provided an option to exclude certain content or concepts from the feed. Further, additional weight may be given to content that the user repeatedly interacts with or purchases made repeatedly by the user. The content may be selected based on one or more progressions relevant to the user. For example, one progression is having a baby where the interests of the user will change in a predictable manner as the baby grows up.

In some instance, the feed may be filtered based on aspects of the user. For example, if a user only buys items made in the USA, the feed is filtered to only include those items. Further, if a user avoids a certain brand, items of that brand are removed from the feed.

In some instances, the feed in the online marketplace may include selected content describing items for sale by brick and mortar stores based on the location of the user. The location of the user may further be used to customize the feed based on the time of day or local weather.

If a user has identified one or more other users as a connection on the online marketplace or a social networking site, the feed of the connection may be used to populate the feed of the user. More specifically, the content of the feed is selected to include products that have been chosen because a social network connection (e.g., a friend) interacted with it (either purchased, shared socially, added to a collection such as a watch list, or actually listed the item). In some instances, users may opt-in to share these interactions with their social network connections. Various content in the feed (such as product descriptions or item listings) are highlighted based on interactions of the user's social network contacts with the content.

A request module 622 may receive and process requests to reveal identities of anonymized users, among other user requests. The request module 622 may generate a message from each received request and work with a communication module 624 to have the message delivered to the user whose identity is being requested to be revealed (e.g., the user providing an interaction). In some embodiments, the request module 622 may cause a poll to be published in the user's name using a social network that the social network connections may respond to either publically or privately.

In some instances, for example where more than one user provides an interaction, the request module 622 may select a portion of the interacting social network connections before working with the communication module 624 to send the request message. The selection may be based on the degree of interaction (e.g., selecting a contact who has purchased a product described by the content and not selecting a contact who has merely viewed the content), a recency of the interaction (e.g., more recent interacting social network contacts are favored over the less recent), or a degree of connection between the users (e.g., if the user and the social network contact communicate directly with one another via the social network). In some instances, the interacting social network contacts may be ranked based on the above factors (e.g., using a weighted algorithm). The users are then requested to reveal themselves in order as the higher ranking contacts refuse to be revealed.

The communication module 624 is responsible for generation and delivery of messages to users of the networked system 100, such as messages requesting to reveal an anonymized user identity or messages revealing the identity of a user. The communication module 624 may utilize any one of a number of message delivery networks and platforms to deliver messages to users. For example, communication module 624 may deliver electronic mail (e-mail), instant message (IM), SMS, text, facsimile, or voice (e.g., Voice over IP (VoIP)) messages via the wired network (e.g., the Internet), Plain Old Telephone Service (POTS), or wireless (e.g., mobile, cellular, WiFi, WiMAX) networks.

FIG. 7 is a flowchart illustrating a method 700 for providing a social product reveal within a user interface of provided by the online marketplace, consistent with some embodiments. The method 700 may be embodied in computer-readable instructions for execution by one or more processors such that the operations of the method 700 may be performed in part or in whole by the application server 126, and in particular, the modules comprising the marketplace application 128.

At operation 705, the user interface module 618 may select content for presentation to a user based on the activity of the user on the network-based marketplace 102. The content may be selected for presentation within a web page or other user interface. For example, the user interface module 618 may select content for presentation in a list of search results, in an item listing page, as part of an item recommendation, or the like. In some instances, the user interface module 618 may work in conjunction with the feed module 620 to select content for inclusion in a marketplace feed.

At operation 710, the application server 126 may identify an interaction with the content provided by a second user having a relationship with the first user. The relationship (e.g., identified by the relationship module 616) may, for example, be based on the first and second users being connected to each other on a social network, being mutually connected to a third user on a social network, having similar purchase histories, having similar browsing histories, having similar interests (e.g., as specified in social data about the users), being members of the same group or organization, or the like. The interaction may be identified from records of interactions maintained in the database 132. In some embodiments, the operation 710 may include obtaining social data (e.g., including a history of interactions) about the user and social network connections of the user from a social network service.

At operation 715, the user interface module 618 may provide instructions to a client device being operated by the user that cause the client device to present the content. The presentation of the content includes an anonymized reference to the interaction provided by the second user. The reference is anonymized in that the identity of the second user (e.g., the user that provided the interaction) is concealed from the first user. In some instances, the anonymized reference to the interaction may identify a relationship between the user and the second user (e.g., “friends”). The presentation of the anonymized reference may further include a user interface element capable of manipulation by the first user to request to reveal the identity of the second user. In an illustrative example of operation 715, a user, John, previously purchased an Apple iPad Mini on the network-based marketplace 102. Upon logging into the homepage for the network-based marketplace 102, Sam, who is “friends” with John on Facebook, may be presented with a marketplace feed that includes the Apple iPad Mini and references the previous purchase of the Apple iPad Mini by John without identifying John as the one who made the purchase (e.g., “A friend of yours purchased this item.”).

At operation 720, the request module 622 may receive a request from the client device of the user to reveal the identity of the second user. The request may include an inquiry related to the content. The request module 622 may then generate a message using the reveal request, and in conjunction with the communication module 624, the request module 622 may transmit the message to the second user (e.g., a messaging account or client device of the second user), at operation 725.

At operation 730, the communication module 624 may receive a response from the second user with confirmation to reveal the identity of the second user. The reply may further include an answer to the inquiry related to the content. At operation 735, the communication module 624 may transmit a message (e.g., based on the reply from the second user) to the client device of the first user revealing the identity of the second user. The revealing of the identity may include presenting an identifier of the second user such as a person's name, a title, a label, a profile name or alias, an email address, or any other moniker from which the first user may identify the second user. The message may also include the answer from the second user regarding the inquiry about the content.

FIG. 8 is a flowchart illustrating a method 800 for routing an inquiry related to an item for which multiple anonymized users have provided an interaction, consistent with some embodiments. The method 800 may be embodied in computer-readable instructions for execution by one or more processors such that the operations of the method 800 may be performed in part or in whole by the application server 126, and in particular, the modules comprising the marketplace application 128.

At operation 805, the user interface module 618 may select content for presentation to a user based on the activity of the user on the network-based marketplace 102. At operation 810, the application server 126 may identify a group of other users having an interaction related to the content. The group of other users may be users of the network-based marketplace 102, social network connections of the user, or both. The interactions provided by each of the group of other members may be a direct interaction with the content, or an interaction with items within the same concept or category as the content. At operation 815, the user interface module 618 may provide instructions to the client device of the user that cause the client device to present the content along with anonymized references to the interactions provided by the group of other users.

At operation 820, the request module 622 may receive an inquiry about the content directed to the group of other users who provided the interaction. At operation 825, the request module may select a portion of the group of other users to provide the inquiry to. The selection of the portion of the group of other users may be based on the selected other users being identified as experts on the content or experts in the category or concept to which the content belongs, consistent with some embodiments. In some embodiments, selection may be based on the degree of interaction (e.g., selecting a contact who has purchased a product described by the content and not selecting a contact who has merely viewed the content), a recency of the interaction (e.g., more recent interacting social network contacts are favored over the less recent), or a degree of connection between the user and the social network contact (e.g., if the user and the social network contact communicate directly with one another via the social network).

At operation 830, the communication module 624 may forward the inquiry to the portion of the group of other users (e.g., to a messaging account or client device of each selected member). At operation 835, the communication module 624 may receive a response from the portion of the group of other users. The response may include an answer to the inquiry and may provide the identity or other identifier of each responding member of the group. At operation 840, the communication module 624 may forward the response to the user (e.g., to a messaging account or a client device of the user).

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a FPGA or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium, for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Machine Architecture

FIG. 9 is a diagrammatic representation of a machine in the example form of a computer system 900 within which a set of instructions for causing the machine to perform any one or more of the methodologies discussed herein may be executed. The computer system 900 may correspond to client devices 104A and 104B, the third party server 106, or application server 126, consistent with some embodiments. The computer system 900 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a STB, a PDA, a cellular telephone, a smart phone (e.g., iPhone®), a tablet computer, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes one or more input/output (I/O) devices 912, a location component 914, a drive unit 916, a signal generation device 918 (e.g., a speaker), and a network interface device 920. The I/O devices 912 may, for example, include a keyboard, a mouse, a keypad, a multi-touch surface (e.g., a touchscreen or track pad), a microphone, a camera, and the like.

The location component 914 may be used for determining a location of the computer system 900. In some embodiments, the location component 914 may correspond to a GPS transceiver that may make use of the network interface device 920 to communicate GPS signals with a GPS satellite. The location component 914 may also be configured to determine a location of the computer system 900 by using an internet protocol (IP) address lookup or by triangulating a position based on nearby mobile communications towers. The location component 914 may be further configured to store a user-defined location in main memory 904 or static memory 906. In some embodiments, a mobile location enabled application may work in conjunction with the location component 914 and the network interface device 920 to transmit the location of the computer system 900 to an application server 122 or third party server 106 for the purpose of identifying the location of a user operating the computer system 900.

In some embodiments, the network interface device 920 may correspond to a transceiver and antenna. The transceiver may be configured to both transmit and receive cellular network signals, wireless data signals, or other types of signals via the antenna, depending on the nature of the computer system 900.

### Machine-Readable Medium

The drive unit 916 includes a machine-readable medium 922 on which is stored one or more sets of data structures and instructions 924 (e.g., software) embodying or used by any one or more of the methodologies or functions described herein. The instructions 924 may also reside, completely or at least partially, within the main memory 904, static memory 906, and/or within the processor 902 during execution thereof by the computer system 900, with the main memory 904, the static memory 906, and the processor 902 also constituting machine-readable media.

Consistent with some embodiments, the instructions 924 may relate to the operations of an OS. Depending on the particular type of the computer system 900, the OS may, for example, be the iOS® operating system, the Android® operating system, a BlackBerry® operating system, the Microsoft® Windows® Phone operating system, Symbian® OS, or webOS®. Further, the instructions 924 may relate to operations performed by applications 116 (commonly known as “apps”), consistent with some embodiments. One example of such an application 116 is a mobile browser application that displays content, such as a web page or a user interface using a browser.

While the machine-readable medium 922 is shown, in an example embodiment, to be a single medium, the term “machine-readable medium” may include a single medium or multiple media (e.g., a centralized or distributed database, and/or associated caches and servers) that store the one or more data structures or instructions 924. The term “machine-readable medium” shall also be taken to include any tangible medium that is capable of storing, encoding, or carrying instructions (e.g., instructions 924) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory including, by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

What is claimed is:

1. A system comprising:
a processor of a machine;
a user interface module to select content for presentation to a first user based on an interaction with the content by a second user, the user interface module further to cause presentation, on a first client device of the first user, of the content interacted with by the second user, the presentation of the content including an anonymized reference to the interaction by the second user, the anonymized reference concealing an identity of the second user; and
a communication module to receive a request to reveal the identity of the second user, the communication module further to transmit the request to a second client device of the second user, the communication module further to receive a confirmation to reveal the identity of the second user, the communication module further to transmit a message to the first client device revealing the identity of the second user based on the confirmation to reveal.

2. The system of claim 1, wherein the selecting of the content performed by the user interface module is based on a relationship between the first user and the second user.

3. The system of claim 2, wherein the relationship is based on the first user and the second user being connected on a social network.

4. The system of claim 2, wherein the relationship is based on the first user being connected to a social network connection of the second user.

5. The system of claim 1, wherein the presentation of the content is within a feed, the feed being a graphical user interface of an aggregation of additional content selected based on interactions by other users for which the first user has a relationship.

6. The system of claim 1, wherein the content corresponds to an item offered for sale; and
wherein the interaction by the second user is a completed purchase of the item.

7. The system of claim 1, wherein the request to reveal further includes an inquiry about the content.

8. A method comprising:
selecting content for presentation to a first user based on activity of the first user;
identifying, using a processor of a machine, an interaction with the content by a second user having a relationship with the first user;
causing presentation of the content on a first client device of the first user, the presentation of the content including an anonymized reference to the interaction by the second user, the anonymized reference concealing an identity of the second user from the first user;
receiving, from the first client device, a request to reveal the identity of the second user;
transmitting a communication to a second client device of the second user requesting the identity of the second user be revealed;
receiving, from the second client device, a confirmation to reveal the identity of the second user; and
in response to receiving the confirmation, revealing the identity of the second user to the first user.

9. The method of claim 8, wherein the selecting the content is further based on the relationship between the first user and the second user.

10. The method of claim 8, wherein the relationship is based on a similar transaction history between the first user and the second user.

11. The method of claim 8, wherein the relationship is based on the first user being on a contact list of the second user.

12. The method of claim 8, wherein the selecting of the content is further based on a recency of the interaction by the second user.

13. The method of claim 8, wherein the content is presented within an item listing page for an item being offered for sale.

14. The method of claim 8, wherein the anonymized reference includes an indicator of the relationship between the first user and the second user.

15. The method of claim 8, wherein the revealing the identity of the second user includes causing presentation of an identifier of the second user.

16. The method of claim 8, wherein the revealing the identity of the second user includes transmitting a message to the first user, the message identifying the second user and including information about the content.

17. The method of claim 8, wherein the request further includes an inquiry about the content, the method further comprising receiving, from the second client device, a response to the inquiry.

18. The method of claim 8, further comprising facilitating further communication between the first user and the second user in response to the receiving the confirmation of the second user to reveal the identity of the second user.

19. The method of claim 8, wherein the content is within a list of search results returned in response to a query submitted by the first user.

20. A non-transitory machine-readable storage medium embodying instructions that, when executed by a machine, cause the machine to perform operations comprising:
selecting content for presentation to a first user based on activity of the first user;
identifying an interaction with the content by a second user;
causing presentation of the content on a first client device of the first user, the presentation of the content including an anonymized reference to the interaction by the second user, the anonymized reference concealing an identity of the second user from the first user;
receiving, from the first client device, a request to reveal the identity of the second user;
transmitting a communication to a second client device of the second user requesting the identity of the second user be revealed;
receiving, from the second client device, a confirmation to reveal the identity of the second user; and
in response to receiving the confirmation, revealing the identity of the second user to the first user.
